(19) United States
(12) Patent Application Publication
(10) Pub. No.: US 2026/0264136 A1
(43) Pub. Date: Sep. 10, 2026

(54) ARRANGEMENT FOR REGENERATING INDUSTRIAL SAND WITH ADDITIVE AND METHOD THEREOF

(71) Applicant: RESAND OY, Nuutajärvi (FI)

(72) Inventors: Toni WESIN, Nuutajärvi (FI); Pekka TASKINEN, Nuutajärvi (FI)

(21) Appl. No.: 19/167,146

(22) PCT Filed: Mar. 19, 2024
(86) PCT No.: PCT/FI2024/050127

§ 371 Date: Sep. 19, 2025

(30) Foreign Application Priority Data
Mar. 22, 2023 (FI) 20235338

(51) Int. Cl. B22C 5/18; B22C 1/18; B22C 5/04; B22C 5/06; B22C 5/08; B22C 5/10

(52) U.S. Cl. CPC B22C 5/18; B22C 1/186; B22C 5/0459; B22C 5/06; B22C 5/10; B22C 5/08

(57) ABSTRACT

In the method, adding (110) an aluminium silicate based additive to industrial sand, heating (120) the industrial sand and the additive added to it, whereby the additive reacts with impurities, that comprise at least alkali metal, in the industrial sand thus forming at least partially melted alkali salts, bringing (130) the heated industrial sand and the alkali salts into a motion occurring in relation to each other, whereby at least part of impurities remaining in the industrial sand adhere to the alkali salts thus forming grains, and separating (140) industrial sand for removing grains from industrial sand. An apparatus for regenerating industrial sand, which apparatus comprises a feeder (220) for feeding industrial sand and an additive to a processing apparatus (300), a processing apparatus (300) for heating the industrial sand and the additive added to it, and further bringing the industrial sand and the additive added to it into a motion occurring in relation to each other, and a separation device (400) configured to separate industrial sand for removing grains from industrial sand.

### BACKGROUND OF THE INVENTION

The invention relates to the regeneration of industrial sand by using an additive. Particularly, the invention relates to the thermo-mechanical regeneration of industrial sand by using an additive.

Typically, industrial sand is set various requirements depending on its use related to its strength, loss of ignition, acid demand value, pH value and/or grain shape. Said requirements are not necessarily met by used industrial sand because the used industrial sand comprises binders and impurities adhered to the sand thus preventing at least some of the above-mentioned requirements from realising.

In accordance with a practice, industrial sand can be thermally regenerated in a fluidized bed reactor or, in accordance with another practice, industrial sand can be regenerated thermo-mechanically in a rotary kiln, that is, a combustion kiln. However, thermally or thermo-mechanically regenerated industrial sand does not fulfil requirements set for its use because the regenerated industrial sand comprises adhesives and impurities adhered to it and thus prevent at least some of said requirements from realising.

### BRIEF DESCRIPTION OF THE INVENTION

The object of the invention is to provide a new type of apparatus and method for regenerating industrial sand.

The method according to the invention is characterised by, in the method, adding an aluminium silicate based additive to the industrial sand. Furthermore, in the method, heating the industrial sand and the additive added to it, whereby the additive reacts with impurities, that contain at least alkali metal, in the industrial sand thus forming at least partially melted alkali salts. Additionally, in the method, bringing the heated industrial sand and the alkali salts to a motion occurring in relation to each other, whereby at least part of impurities remaining in the industrial sand adhere to the alkali salts thus forming grains. In the method, further separating the industrial sand for removing the grains from the industrial sand.

An apparatus according to the invention is characterised by the apparatus comprising a feeder for feeding industrial sand and an additive to a processing apparatus. Furthermore, the apparatus comprises a processing apparatus for heating the industrial sand and the additive added to it and, additionally, for bringing the industrial sand and the additive added to it to a motion occurring in relation to each other. The apparatus further comprises a separation device for separating the industrial sand for removing grains from it.

An advantage of the method and apparatus according to the invention is that the physical-chemical processing performed in the processing apparatus substantially removes binders and impurities from the industrial sand.

Some embodiments of the invention are presented in the dependent claims.

### BRIEF DESCRIPTION OF THE DRAWINGS

The invention will now be described in closer detail in connection with preferred embodiments and with reference to the accompanying drawings, in which

FIG. 1 schematically shows a method for regenerating industrial sand,

FIG. 2 schematically shows another method for regenerating industrial sand,

FIG. 3 very schematically shows an apparatus for implementing the method of FIGS. 1 and 2, and

FIG. 4 very schematically shows another apparatus for implementing the method of FIG. 1.

### DETAILED DESCRIPTION OF THE INVENTION

Industrial sand refers to regeneratable sand that has been used in industry, such as in the foundry industry. Industrial sand can be e.g. phenolic resin sand that comprises organic resin as a binder and an additive added to the binder, wherein the additive added to the binder can be e.g. an ester hardener. Industrial sand can be green sand that comprises at least bentonite as a binder and an additive added to the binder, wherein the additive added to the binder can be e.g. carbon. Industrial sand can be furane resin sand. Industrial sand comprises impurities that contain alkali metal, such as e.g. potassium and/or sodium. Impurities in industrial sand can lie in the binder of the industrial sand and on the surface of a sand grain of the industrial sand. There can be requirements related to industrial sand for end-use concerning sand firmness, loss of ignition (LOI), acid demand value (ADV), shape of sand grains and/or cracks that possibly occur in sand grains. It should be mentioned that industrial sand can refer to regeneratable sand that has been used e.g. in the power industry. As a binder, power plant sand can comprise e.g. a clay-based impurity film.

For example, when industrial sand is regenerated thermo-mechanically, industrial sand is heated and brought into a motion mechanically by means of a kiln, wherein binders in the industrial sand are at least partially released as a result of heat and collisions, but wherein impurities on the surface of sand or sand grain are not released sufficiently. When industrial sand regenerated thermally or thermo-mechanically is re-used, said impurities can hamper the use of regenerated sand e.g., such that the impurities prevent the binder to be added to the sand from working, wherein the binder affects the requirements related to industrial sand. For instance, impurities that comprise alkali metal compounds, such as e.g. potassium residues, can remain in green sand that has been thermally or thermo-mechanically regenerated, and they prevent a binder, such as e.g., bentonite, in the green sand in the foundry industry from working, whereby the target firmness set for sand is not realised. The prevention of the binder from working can lead to that larger quantities of binders are used in industrial sand to realise the requirements set for sand.

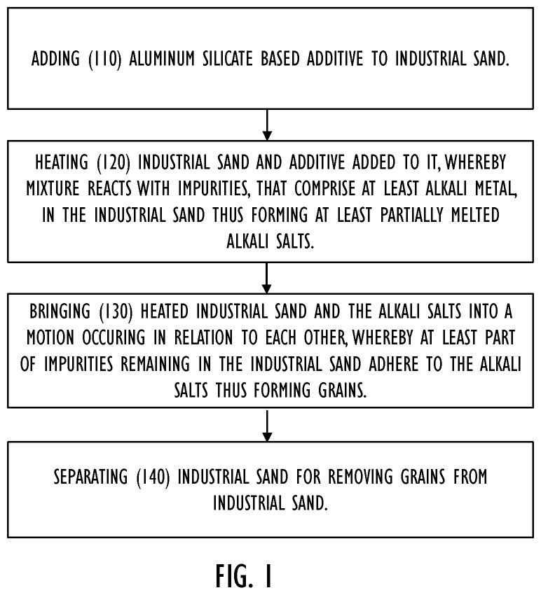

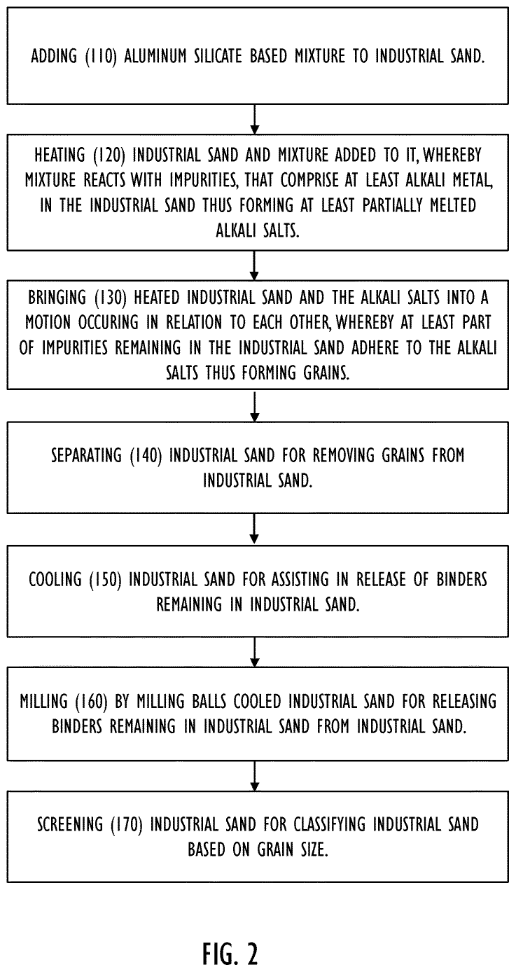

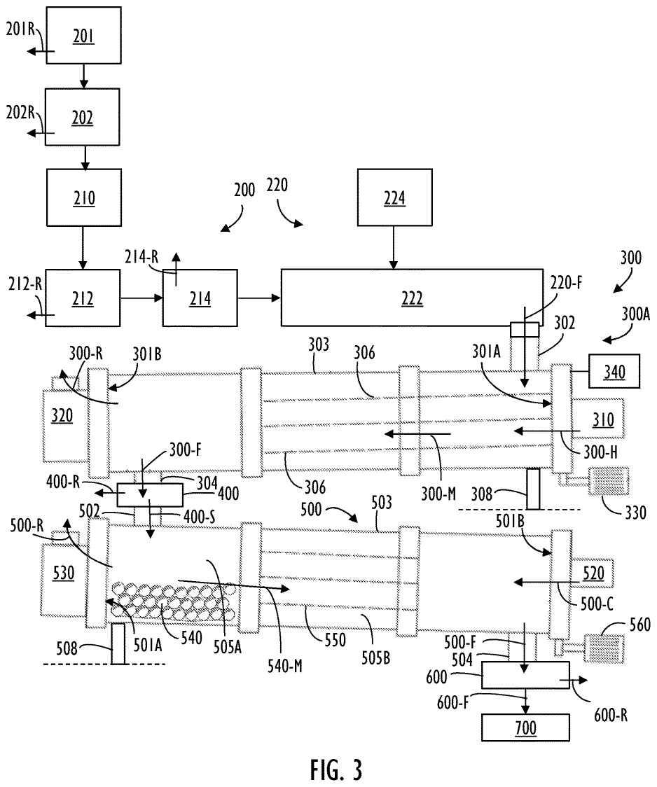

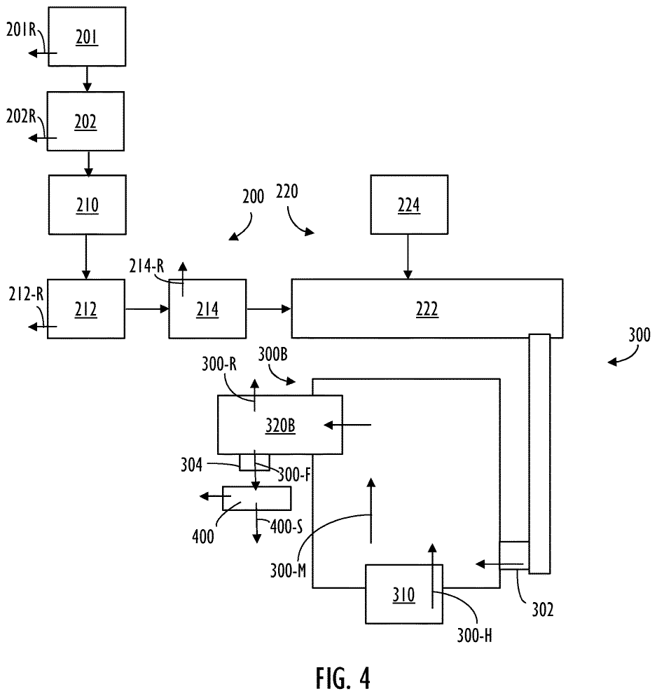

FIG. 1 shows a method for regenerating industrial sand. FIG. 2 shows another method for regenerating industrial sand. FIG. 3 shows an apparatus that comprises a processing apparatus 300 based on a thermo-mechanical operating principle, which processing apparatus 300 is a rotary kiln 300A, that is, a burning kiln 300A. FIG. 4 shows an apparatus that comprises a processing apparatus 300 based on a thermal operating principle, which processing apparatus 300 is a fluidized bed reactor 300B.

The apparatus of the figures comprises a feeder 220, a processing apparatus 300 and a separation device 400. The feeder 220 is configured to feed industrial sand and an additive to the processing apparatus 300, or more specifically, the feeder is configured to feed the industrial sand and the additive added to it to the processing apparatus 300, wherein the additive will be described in more detail below. The processing apparatus 300 is configured to heat 120 the industrial sand and the additive added to it, whereby the additive reacts with impurities, that contain at least alkali metal, in the industrial sand thus forming at least partially melted alkali salts. Additionally, the processing apparatus 300 is configured to bring 130 the heated industrial sand and the alkali salts to a motion occurring in relation to each other, whereby at least part of impurities remaining in the industrial sand adhere to the alkali salts thus forming grains. In more detail, said alkali salts thus forms grains or agglomerates of grains. The separation device 400 is configured to separate industrial sand for removing grains from it. The separation device 400 is configured to separate industrial sand for removing grains and agglomerates from it.

Removal of impurities occurs as a result of a physico-chemical event. Industrial sand is heated and brought into a motion, whereby binders in the industrial sand are burned and released, wherein e.g., carbon, in the industrial sand burns away by the effect of heat. The industrial sand and the additive added to it are heated e.g. to 500-850° C., 600-800° C., 650-750° C. or 700-750° C. The additive reacts with impurities in the industrial sand and released from the industrial sand thus forming at least partially melted alkali salts. In more detail, the additive reacts with impurities in the binders of the heated industrial sand thus forming at least partially melted alkali salts, which said impurities are in this stage in their melted state when reacting with the additive. E.g. an aluminium silicate based additive or e.g. an aluminium hydroxide silicate based additive or e.g. a kaoline containing additive reacts with impurities in the heated industrial sand thus forming at least partially melted alkali salts. Additionally, heated industrial sand and at least partially melted alkali salts are brought to a motion occurring in relation to each other, whereby at least part of impurities remaining in the industrial sand adhere to the alkali salts thus forming grains. In more detail, at least part of impurities remaining on the surface of a sand grain of industrial sand adhere to alkali salts thus forming grains. Furthermore, grains agglomerate with industrial sand and impurities and binders existing in and/or released from industrial sand and thus form increasing, i.e. larger sized grains, pellets and agglomerated clusters. It should be mentioned that the alkali salts melt at least partially in a temperature lower than the temperature of industrial sand thus assisting the forming of grains. It should be mentioned that the at least partially melted alkali salts can be totally melted alkali salts. For clarity, it should be mentioned that said alkali salts release impurities on the surface of industrial sand by adhering to impurities on the surface of the industrial sand thus forming grains when combined, after which, at least part of grains are separated from the industrial sand.

The additive can be aluminium silicate based (Al₂O₃—SiO2). The additive can be aluminium hydroxide silicate based Al₂Si₂O₅(OH)₄ (Al₂O₃·2SiO₂·2H₂O). The additive can comprise one of the following: andalusite, kaolin (H₂Al₂Si₂O₈·H₂O), kyanite, and/or sillimanite. The aluminium silicate minerals of the additive to be added to industrial sand are in their solid state. The additive can comprise liquid, such as e.g. water, whereby the additive to be added to industrial sand is in liquid state, or in other words, whereby the additive to be added to industrial sand is a suspension. The consistence of the additive is determined such that it melts in a temperature higher than the heated industrial sand. The melting point of the additive can be e.g. over 1000° C. The additive is added to industrial sand for such a quantity that there is e.g. 0.2-5.0 percentage by weight of aluminium silicate minerals in relation to industrial sand, or e.g. 0.3-4.0 percentage by weight in relation to industrial sand, or e.g. 0.5-3.0 percentage by weight in relation to industrial sand. Alkali salts or grains can be in their at least partially melted state e.g. in 500-850° C., or e.g. in 500-700° C., or e.g. at least in 500-850° C., or e.g. at least in 500-700° C. The melting point of alkali salts or grains can be e.g. in 700-1100° C., or e.g. in 700-850° C., or e.g. at least in 700-1100° C.

Industrial sand to be regenerated is pre-processed before feeding it to the processing apparatus 300. The apparatus of the figures comprises a pre-processing apparatus 200. The pre-processing apparatus 200 comprises a crushing device 201 which is configured to crush pieces, such as e.g. moulds, formed of industrial sand into smaller sand lumps and industrial sand. The industrial sand is guided forward to a classification device 202 and sand lumps are removed 201-R and possibly pre-processed in the crushing device 201 again. The crushing device 201 can be e.g. a gyratory crusher, a roll crusher, an impact crusher, a jaw crusher, a hammer crusher, or a coil crusher.

In addition, the pre-processing apparatus 200 comprises a classification device 202, which divides industrial sand processed by the crushing device 201 into different quality classes, e.g. by means of air classification. The quality classification can be based on e.g. the grain size of sand. Industrial sand having a specific quality classification is guided to an industrial sand container 210, and the rest of industrial sand and particles in it are removed 202-R for some other use or to be re-processed. The classification device 202 can be e.g. connected to the crushing device 201, or the classification device 202 can e.g. receive sand processed by the crushing device 201 e.g. by means of conveyance.

Furthermore, the pre-processing apparatus 200 comprises an industrial sand container 210 or, in other words, an industrial sand hopper 210, where the crushed industrial sand having a specific quality class is stored for regeneration. The industrial sand container 210 can be connected to the classification device 202. The industrial sand container 210 comprises a feeder for feeding industrial sand forward.

Additionally, the pre-processing apparatus 200 comprises a grinder 212 for grinding industrial sand. By means of the grinder 212, vibration is applied to industrial sand, whereby mechanical grinding is applied to industrial sand, that assists in the breaking up or releasing of binders in industrial sand from the industrial sand. Said grinder can be e.g. a substantially vertical column grinder which can comprise e.g. a screw-like rotatable blade or vane for producing said mechanical impacts to industrial sand being processed, whereby both the impacts applied directly to industrial sand by the blade and the mutual grinding of sand grains occurring inside the industrial sand being ground release the binder and carbon possibly contained by it from the surface of sand grains. Alternatively, said grinder can be a substantially horizontal drum grinder which can comprise e.g. two drums rotating in relation to each other one inside the other, whereby said drums produce mechanical impacts to industrial sand being fed between the kilns, whereby both the impacts applied directly to the industrial sand by the drums and the mutual grinding of sand grain within the industrial sand being ground release the binder and carbon possibly contained by it from the surface of sand grains. The grinder 212 can be connected to the industrial sand container 210. The released binder and carbon are removed 212-R and guided to some other use which is not discussed further in this context. Instead of the grinder 212 for grinding the industrial sand, the pre-processing apparatus 200 may comprise an attritor for grinding the industrial sand. Alternatively, the grinder 212 may be an attritor.

Furthermore, the pre-processing apparatus 200 comprises a metal separation apparatus 214 for removing metals in industrial sand. The metal separation apparatus 214 can comprise e.g. a conveyor and a magnet connected into connection with the conveyor, which conveyor is configured to convey industrial sand to the feeder 220, and which magnet is configured to remove 214-R metals in industrial sand. Said magnet may be called a magnet device. According to an embodiment, the feeder 220 described later is connected below the grinder 212, wherein the metal separating apparatus 214 is a magnet located in an area between the grinder 212 and the feeder 220, which magnet removes metals and other ferro-magnetic substances in industrial sand when the industrial sand drops from the grinder 212 to the feeder 220.

The apparatus of the figures comprises a feeder 220 for feeding industrial sand and the additive to the processing apparatus 300. The feeder 220 is configured to receive pre-processed industrial sand. In more detail, the feeder 220 is configured to receive industrial sand pre-processed in the pre-processing apparatus 200. The feeder 220 of the figures comprises a conveyor 222. The conveyor 222 can be e.g. a belt conveyor, or the feeder can be e.g. a screw conveyor 222. Additionally, the feeder 220 can comprise an additive feeder 224 for adding the additive to industrial sand on the conveyor 222. The additive feeder 224 is connected to the conveyor 222. By means of the feeder 220, the additive can be added to industrial sand evenly, or more specifically, by means of the feeder 220, the additive can be mixed with industrial sand evenly. The feed rate of the additive feeder 224 can be adjusted to reach a suitable additive ratio. The speed of the conveyor 222 can be adjusted to the quantity of the industrial sand and the additive being fed be suitable in relation to the line speed of the processing apparatus 300. According to an embodiment, the feeder 220 can be a feeder 220 based on the use of gravity, wherein industrial sand is dropped to the processing apparatus and wherein the feeder 220 feeds the additive in a specific ratio among the industrial sand dropping to the processing apparatus.

The processing apparatus 300 of the apparatus of the figures will be next described in more detail. The processing apparatus 300 comprises at least an inlet 302 for receiving industrial sand and additive. The processing apparatus 300 further comprises a heating device 310 configured to heat 300-H the industrial sand and the additive added to it, whereby the additive reacts with impurities, that contain at least alkali metal, in the industrial sand thus forming at least partially melted alkali salts. The processing apparatus 300 additionally comprises means configured to bring 300-M the industrial sand and the at least partially melted alkali salts to a motion occurring in relation to each other, whereby at least part of impurities remaining in the industrial sand adhere to the alkali salts thus forming grains. The processing apparatus 300 further comprises an outlet 304 for feeding industrial sand and formed grains 300-F to a separation device 400.

The processing apparatus 300 of FIG. 3 is a rotary kiln 300A, or in other words a burning kiln 300A, or in other words a rotary furnace 300A, or in other words a rotary furnace 300A. The rotary kiln 300A comprises a container 303 where industrial sand is processed. The rotary kiln 300A, or in more detail the container 303 of the rotary kiln 300A, includes a first end 301A and a second end 301B. The first end 301A and the second end 301B are located at opposite ends in relation to each other. In more detail, the container 303 is a longitudinal hollow cylinder or a cylindrical construction.

Furthermore, the rotary kiln 300A comprises an inlet 302 for receiving industrial sand and additive. The inlet 302 is connected to the feeder 220. The inlet 302 is located close to said first end 301A. In addition, the rotary kiln 300A comprises an outlet 304 for feeding industrial sand and grains out of the rotary kiln 300A. The outlet 304 is connected to the separation device 400. The outlet 304 is located close to said second end 301B. In FIG. 3, the inlet 302 and the outlet 304 of the rotary kiln 300A are located at opposite ends in relation to each other.

Furthermore, the rotary kiln 300A comprises lifters 306, or in other words shovels 306, or in other words vanes 306, which assist in bringing industrial sand and above-mentioned alkali salts into a motion inside the rotary kiln 300A. The lifters 306 are located inside the rotary kiln 300A or more specifically inside the container 303. The lifters 306 are shaped such that they bring industrial sand and alkali salts from the first end 301A towards the second end 301B of the rotary kiln 300A. When the rotary kiln 300A rotates, the lifters 306 lift industrial sand upward until the industrial sand drops at a specific height from the vane 306 onto the bottom of the rotary kiln 300A, whereby the particles of the industrial sand collide each other, which assists in releasing the binders in the industrial sand. Additionally, the dropping of the industrial sand from the vane 306 onto the bottom of the rotary kiln 300A assists the industrial sand to receive thermal energy when the thermal energy is applied to the dropping industrial sand.

The rotary kiln 300A further comprises a base 308, on top of which the rotary kiln 300A is located, which base 308 is shown very schematically in FIG. 3. By means of the base 308, the rotary kiln is set to an angular position, or in other words inclination, in relation to the horizontal plane, by means of which angular position, it is possible to affect the speed of propagation of industrial sand in the rotary kiln 300A. The base 308 can be an adjustable base 308 for changing the angular position of the rotary kiln. The angle between the rotary kiln 300A and the horizontal plane can be e.g. 0.5-5.0 degrees. The adjustable base 308 can operate e.g. hydraulically.

Furthermore, the rotary kiln 300A comprises a heating device 310 for heating industrial sand and additive. The heating device 310 is configured to heat 300-H the industrial sand and the additive added to it by feeding thermal energy to the rotary kiln. The heating device 310 can comprise e.g. a burner, an electric resistor, a plasma source, or an induction device for feeding thermal energy to the rotary kiln, wherein thermal energy can thus be e.g. combusted gas, heated air applied directly at industrial sand, or heated air applied indirectly to industrial sand via the constructions of the processing apparatus. The heating device 310 is connected to the first end 301A.

The rotary kiln 300A additionally comprises an air exhaust device 320, through which, thermal energy, air mass and exhaust gases and flue dust possible in the air mass located in the rotary kiln 300A is removed 300-R. An exhaust gas filter for filtering exhaust gases, a heat recovery system for recovering heat, and/or a dust filter for filtering dust, can be connected to the air exhaust device 320. In more detail, the exhaust filter of the air exhaust device is for removing solids from exhaust gases. The air exhaust device 320 is located at the opposite end in relation to the heating device 310, or in other words, the air exhaust device 320 is located at the second end 301B of the rotary kiln 300A. Said arrangement assists in applying thermal energy to industrial sand in an efficient way.

In addition, the rotary kiln 300A comprises a motor 330 for rotating the rotary kiln 300A. The motor 330 is configured to rotate the rotary kiln 300A and the lifters 306 contained by it for rotating industrial sand, wherein the rotation speed of the rotary kiln 300A and the lifters can be e.g. 5-20 rotations per minute (rpm). The rotation of industrial sand assists in feeding thermal energy to the industrial sand. The rotary kiln 300A comprises required means, such as e.g. bearings, toothed carriers and/or gears connected to the motor 300 for allowing the rotation of the rotary kiln 300A. The rotation speed of the motor 330 and thus of the rotary kiln 300A can be adjusted, wherein the rotation speed of the rotary kiln affects the motion speed of industrial sand and, hence, the magnitude of forces applied to industrial sand.

Furthermore, the rotary kiln 300A comprises a control unit 340 for adjusting the parameters of the rotary kiln 300A and specifying the size of the thus formed grains. The control unit 340 can affect the lead time of industrial sand in the rotary kiln 300A and the physico-chemical reaction occurring in industrial sand. The control unit 340 is shown in FIG. 3 very schematically and generally connected to the rotary kiln 300A. The control unit is configured to control the quantity of received industrial sand and additive added to it. Furthermore, the control unit is configured to regulate the quantity of thermal energy fed by the heating device 310. Additionally, the control unit is configured to control the quantity of air mass removed by the air exhaust device 320. In addition, the control unit is configured to adjust the angle of the rotary kiln in relation to the horizontal level by adjusting the position of the base 308. The control unit is further configured to manage the rotation speed of the motor 330 of the rotary kiln 300A. The parameters of the rotary kiln 300A can be adjusted and thus affect the size of above-mentioned grains to be formed. The lead time of processed industrial sand through the rotary kiln can be adjusted to e.g. 10-60 minutes. The size of the formed grains can be e.g. 3-10 mm, or e.g. 4-8 mm, or e.g. 5-6 mm.

The apparatus of the figures comprises a separation device 400 configured to separate industrial sand for removing grains from it. The separation device 400 is connected to the processing apparatus 300, or more specifically, the separation device 400 is connected to the outlet 304 of the processing apparatus 300. Industrial sand is separated from grains based on grain size, wherein in the separation, the grain size of industrial sand is smaller than the grain size of grains. The separation device 400 can be a sieve, or in other words, a screen net with its mesh size being dimensioned smaller than the formed grains, or in other words, the parameters used in the regeneration of industrial sand are adjusted such that the size of the grains to be formed is larger than the mesh size of the dimensioned sieve. The separation device 400 can be a vibrating table comprising a screen of specific size. Industrial sand with particle size below the specific size gets through 400-S the separation device, whereby industrial sand and the formed grains with particle size over the specific size do not thus get through the separation device. Industrial sand and formed grains not having got through the screen of the separation device 400 are removed 400-R and possibly processed further. In said further processing, the formed grains can be refined into secondary products, and the industrial sand in said further processing can be guided back e.g. to the pre-processing apparatus 200 or the feeder 220 of the apparatus. The mesh size of the sieve can be e.g. 1-5 mm, or e.g. 2-4 mm, or e.g. about 2-3 mm.

The apparatus of FIG. 3 comprises a cooling kiln 500. The cooling kiln 500 comprises a container 503 wherein industrial sand is cooled. The cooling kiln 500, or more specifically its container 503, includes a first end 501A and a second end 501B. The first end 501A and the second end 501B are located at opposite ends in relation to each other. The container 503 is more specifically a longitudinal hollow cylinder or a cylindrical construction.

Furthermore, the cooling kiln 500 comprises an inlet 502 for receiving separated industrial sand. The inlet 502 is connected to the separation device 400, or more specifically, the inlet 502 is connected to the screen of the separating device 400 or in connection with it. The inlet 502 is located close to said first end 501A. Additionally, the cooling kiln 500 comprises an outlet 504 for feeding industrial sand out of the cooling kiln 500 to a classifying device 600, wherein the outlet 504 is connected to the classifying device 600, which will be described in more detail below. The outlet 504 is located close to said second end 501B. In other words, the inlet 502 and the outlet 504 are located at opposite ends in relation to each other.

Additionally, the cooling kiln 500 comprises a base 508, on top of which the cooling kiln 500 is located, which base 508 is shown very schematically in FIG. 3. By means of the base 508, the cooling kiln is set at an angular position in relation to the horizonal plane, which angular position can affect the propagation speed of industrial sand in the cooling kiln 300A. The base 508 can be an adjustable base 508 for changing the angular position of the cooling kiln. The adjustable base 308 can operate e.g. hydraulically.

In addition, the cooling kiln 500 comprises an air feeding device 520 for feeding cooling air to the cooling kiln for releasing latent thermal energy existing in industrial sand from the industrial sand. The cooling kiln is configured to cool 500-C industrial sand by feeding cooling air to the cooling kiln 500. The cooling air can be air of the temperature prevailing in a space outside the cooling kiln. The air feeding device 520 is located at the second end 501B of the cooling kiln. The feeding of cooling air to the cooling kiln makes the temperature of industrial sand to decrease, which assists in releasing the binder residues from the industrial sand.

In addition, the cooling kiln 500 comprises an air exhaust device 530 for receiving cooling air and for receiving thermal energy released from industrial sand, through which air exhaust device, the cooling air flowing through the cooling kiln 500 and possible dust contained by it are removed. The air exhaust device 530 is configured to remove 500-R air mass and possible dust contained by it from the cooling kiln. The air exhaust device 530 is located at the opposite end in relation to the air feeding device 520, or in other words, the air exhaust device 530 is located at the first end 501A of the cooling kiln 500. A dust filter can be connected to the air exhaust device 530 for filtering dust and various binder residues, and a recovery system of thermal energy can be connected to the air exhaust device 530 to recover thermal energy.

The cooling kiln 500 further comprises milling balls 540 for milling cooled industrial sand and thus for releasing the remaining binder residues from the industrial sand. The milling balls 540 can be in other words grinding balls 540. Milling can in other words be grinding. The cooling kiln comprises a milling compartment 505A, where the milling balls 540 are arranged. The milling compartment 505A starts from the first end 501A of the cooling kiln 500 and extends to a specific distance from said first end 501A. The milling compartment 505A can be divided from the other part of the cooling kiln e.g. by means of a wall baffle with openings located inside the cooling kiln. Industrial sand is milled 540-M by the milling balls. The milling of industrial sand with milling balls 540 and the simultaneous cooling of industrial sand assists in releasing binders remaining in the industrial sand from the industrial sand. The industrial sand in the cooling kiln has already been milled once in the rotary kiln and, further, the temperature of the industrial sand in the cooling kiln is cooler than the industrial sand in the rotary kiln, whereby the milling even applied to the industrial sand is different from the milling even occurring in the rotary kiln, which assists in releasing the binders remaining in the industrial sand from the industrial sand.

The cooling kiln 500 further comprises lifters 550, or in other words shovels 550, which assist in bringing the industrial sand into a motion inside the cooling kiln 500. The lifters 550 are shaped such that they accompany the industrial sand from the first end 501A of the cooling kiln 500 toward the second end 501B. The lifters 550 are located in a vane compartment 505B, wherein the vane compartment 505B is at a specific distance from the milling compartment 505A extending at a specific distance in relation to the second end 501B of the cooling kiln 500. When the cooling kiln 500 rotates, the lifters 550 lift industrial sand upward until the industrial sand at a specific height drops from the vane 550 onto the bottom of the cooling kiln 500, which assists industrial sand to release thermal energy in it to cooling air flowing through the industrial sand. Furthermore, the dropping of industrial sand onto the bottom of the cooling kiln brings about collisions of industrial sand particles to each other, which assists in the release of binders in industrial sand from the industrial sand.

Additionally, the cooling kiln 500 comprises a motor 560 for rotating the cooling kiln 500. The cooling kiln 500 comprises required means, such as e.g. bearings, toothed carrier rings and/or gears connected to the motor 560 for rotating the cooling kiln 500.

The apparatus of the figures comprises a classification device 600 configured to classify 600-F industrial sand, which industrial sand has been processed thermo-mechanically in the rotary kiln 300A, and which industrial sand has been further processed mechanically, that is, by milling in the cooling kiln 500. The classification device 600 comprises at least one screen for classifying industrial sand based on grain size. The classification device 600 thus comprises a first screen with a specific mesh size. Industrial sand that passes the first screen forms the first quality class of industrial sand. Furthermore, industrial sand that has passed the first screen can be guided to a second screen with a specific mesh size smaller than the first screen. Industrial sand that has passed the second screen forms the second quality class of industrial sand. The classification device can comprise n number of screens (n=1, 2, 3, 4, 5 . . . ). Industrial sand that has not passed the first screen is removed 600-R for some other use or guided e.g. to reprocessing or to the feeder 220. The mesh size or mesh sizes of the screen can be e.g. 0.1 mm, 0.2 mm, 0.5 mm and/or 1.0 mm.

The apparatus of FIG. 3 comprises a postprocessing device 700 which can be e.g., a storage, transport, or industry process of industrial sand.

The processing apparatus 300 of the apparatus of FIG. 4 is a fluidized bed reactor 300B. The fluidized bed reactor comprises an inlet 302 and an outlet 304. The fluidized bed reactor 300B is configured to receive the industrial sand and the additive from the feeder 220. The fluidized bed reactor 300B comprises a heating device 310 for heating industrial sand and additive added to it. The heating device 310 can be e.g. a gas burning device. The heating device 310 brings the heated industrial sand and the alkali salts into a motion occurring in relation to each other, whereby at least part of remaining impurities adhere to the alkali salts thus forming grains. The fluidized bed reactor 310B comprises a processing device 320B, such as e.g. a cyclone, through which burned gases are guided in the process to the further processing of gases, and through which the industrial sand and the formed grains are guided to the separation device 400. It is further possible to connect the cooling kiln 500, the classification device 600 and/or the post processing device 700 to the apparatus of FIG. 4, but they are not shown in FIG. 4 for the sake of clarity.

According to a first example, the following arrangement has been implemented to regenerate industrial sand. Industrial sand is phenolic resin sand, i.e. sand bound with organic resins, that has been regenerated by using the feeder 220, the rotary kiln 300A and the separator 400 of FIG. 3. Phenolic resin sand comprises carbon and alkali metal as binders, wherein alkali metal comprises potassium. An additive is added in relation to industrial sand such that there is about 1 percentage by weight kaolin to industrial sand. The industrial sand and the additive added to it are heated to 500-850° C., whereby the additive reacts with impurities, that comprise at least alkali metal, in the industrial sand forming at least partially melted alkali salts. Within said temperature range, carbon in the phenolic resin sand burns off. Industrial sand and alkali salts are brought into a motion occurring in relation to each other, whereby at least part of impurities remaining in the industrial sand adhere to alkali salts thus forming grains, wherein the size of the formed grains is about 5-10 mm. The rotation speed of the rotary kiln 300A is about 5-20 rpm and the angular position of the rotary kiln 300A in relation to the horizontal level is about 0.5-5.0 degrees, whereby industrial sand is processed thermo-mechanically for about 10-60 min. When loss of ignition of industrial sand is after the thermo-mechanical processing about 1.5 per cent, pH value of industrial sand is about 10-11 and its electrical conductivity about 1000 EC.

According to a second example, an arrangement corresponding the first example is implemented, but there is about 1.5 percentage by weight of kaolin in the additive in relation to industrial sand. When loss of ignition of industrial sand is after the thermo-mechanical processing about 1.5 per cent, pH value of industrial sand is about 9.0-9.5 and its electrical conductivity about 400 EC.

According to a third example, an arrangement corresponding the first example is implemented, but there is about 2.0 percentage by weight of kaolin in the additive in relation to industrial sand. When loss of ignition of industrial sand is after the thermo-mechanical processing about 1.5 per cent, pH value of industrial sand is about 7.5-8.2 and its electrical conductivity about 200 EC.

According to a fourth example, an arrangement corresponding the first example is implemented, but industrial sand is green sand which comprises bentonite and alkali metal as binders, wherein alkali metal comprises potassium. For clarity, it should be mentioned that the additive is added to industrial sand such that there is about 1 percentage by weight of kaolin in the additive in relation to industrial sand. When loss of ignition of industrial sand is about 1.5 per cent, pH value of industrial sand is about 8.4 and its electrical conductivity about 150 EC.

According to a fifth example, an arrangement corresponding the fourth example is implemented, but there is about 1.5 percentage by weight of kaolin in the additive in relation to industrial sand. When loss of ignition of industrial sand is after the thermo-mechanical processing about 1.5 per cent, pH value of industrial sand is about 8.0 and its electrical conductivity about 100 EC.

According to a sixth example, an arrangement corresponding the fourth example is implemented, but there is 2.5 percentage by weight of kaolin in the additive in relation to industrial sand. When loss of ignition of industrial sand is after the thermo-mechanical processing about 1.5 per cent, pH value of industrial sand is about 7.4 and its electrical conductivity about 30 EC.

Those skilled in the art will find it obvious that, as technology advances, the basic idea of the invention may be implemented in many different ways. The invention and its embodiments are thus not restricted to the examples described above but may vary within the scope of the claims.

1. A method for regenerating industrial sand, in which method,
adding an aluminium silicate based additive to industrial sand,
heating the industrial sand and the additive added to it, whereby the additive reacts with impurities, that comprise at least alkali metal, in the industrial sand thus forming at least partially melted alkali salts,
bringing the heated industrial sand and the alkali salts into a motion occurring in relation to each other, whereby at least part of impurities remaining in the industrial sand adhere to the alkali salts thus forming grains, and
separating the industrial sand for removing grains from the industrial sand.

2. A method according to claim 1, in which method, bringing the heated industrial sand and the alkali salts into a motion occurring in relation to each other in a rotary kiln thus assisting in the formation of grains.

3. A method according to claim 1, in which method, heating the industrial sand and the additive added to it to 500-850° C.

4. A method according to claim 1, in which method, when heating the industrial sand and the additive added to it, the additive reacts with impurities, that comprise at least alkali metal, in the binders of the industrial sand thus forming at least partially melted alkali salts, and in which method, bringing the heated industrial sand and the alkali salts into a motion occurring in relation to each other, and at least part of impurities remaining on surfaces of sand grain of the industrial sand adhere to the alkali salts thus forming grains.

5. A method according to claim 1, in which method, the industrial sand is green sand.

6. A method according to claim 1, in which method, the industrial sand comprises organic resin as a binder.

7. A method according to claim 1, in which method, separating the formed grains from the industrial sand based on grain size.

8. A method according to claim 1, in which method further
cooling industrial sand for assisting in the release of binders remaining in the industrial sand,
milling by milling balls the cooled industrial sand for releasing the binders remaining in the industrial sand from the industrial sand, and
screening the industrial sand for classifying the industrial sand based on grain size.

9. A method according to claim 1, in which method, the additive comprises one of the following aluminium silicate minerals: andalusite, kaolin, cyanite or sillimanite.

10. An apparatus for regenerating industrial sand according to the method as claimed in claim 1, which apparatus comprises
a feeder for feeding industrial sand and an additive to a processing apparatus,
a processing apparatus for heating the industrial sand and the additive added to it, and further for bringing the industrial sand and the additive added to it into a motion occurring in relation to each other, and
a separation device configured to separate industrial sand for removing grains from industrial sand.

11. An apparatus according to claim 10, wherein the feeder comprises
a conveyor for receiving industrial sand and further guiding to the processing apparatus, which conveyor is connected to the processing apparatus, and
an additive feeder for adding the additive to industrial sand on the conveyor.

12. An apparatus according to claim 11, wherein the conveyor is a screw conveyor.

13. An apparatus according to claim 10, wherein the processing apparatus is a rotary kiln comprising
an inlet connected to the feeder,
a heating device configured to heat the industrial sand and the additive in the rotary kiln,
a motor configured to rotate the rotary kiln for bringing the industrial sand and the additive added to it into a motion occurring in relation to each other,
a control unit for adjusting the parameters of the rotary kiln and for specifying the size of grains to be formed, and
an outlet connected to the separation device.

14. An apparatus according to claim 10, wherein the separation device is a screen which separates grains from industrial sand based on grain size.

15. An apparatus according to claim 10, wherein the apparatus further comprises a cooling kiln, the cooling kiln comprising
an inlet connected to the separation device for receiving separated industrial sand,
an air feeding device for feeding cooling air to the cooling kiln for releasing thermal energy in the industrial sand from the industrial sand,
an air exhaust device for receiving cooling air and for receiving thermal energy released from industrial sand,
milling balls for milling cooled industrial sand for releasing binders remaining in industrial sand,
a motor for rotating the cooling kiln, milling balls and industrial sand, and
an outlet for feeding industrial sand forward.

16. An apparatus according to claim 15, wherein the apparatus comprises a classification device connected to the outlet of the cooling kiln, the classification device comprising at least one screen for classifying industrial sand based on grain size.
